(19) United States
(12) Patent Application Publication
(10) Pub. No.: US 2019/0266642 A1
(43) Pub. Date: Aug. 29, 2019

(54) DYNAMIC NETWORKED SIGNAGE DISTRIBUTION AND PRESENTMENT

(71) Applicant: NCR Corporation, Duluth, GA (US)

(72) Inventors: Justin David Orr, Pinehurst, TX (US); Josiah David Blaisdell, College Station, TX (US); Jack Eugene Edwards, JR., Cypress, TX (US); Lawrence Dustin Rowe, Bryan, TX (US); Joseph Laval Tremblay, College Station, TX (US)

(21) Appl. No.: 15/907,022

(22) Filed: Feb. 27, 2018

(51) Int. Cl. G06Q 30/02; G06F 17/30

(52) U.S. Cl. CPC G06Q 30/0264; G06Q 50/12; G06F 17/30876

(57) ABSTRACT

Various embodiments herein each include at least one of systems, methods, and software for dynamic network signage distribution and presentment. One method embodiment includes reading data from a content schedule for digital display system. The content schedule data including data identifying a digital asset retrievable from a URI, at least one digital sign on which to present the digital asset, at least one location on each of the at least one digital signs at which the digital asset is to be presented. The method further includes retrieving the digital asset over a network based on the URI and according to the schedule data and invoking a web browser display function to present the retrieved digital asset. This method further includes presenting the retrieved digital asset on each of the at least one digital signs at each identified location thereon.

### BACKGROUND INFORMATION

Signage in stored has evolved in recent years from being terminally static to being digital and time adjusted. Such signs in quick-serve restaurants include digital displays that present digital content, which is typically static for a period. Some of these solutions include a schedule that allows for the digital content to change with the time of day, such as presenting a breakfast menu in the morning and a lunch and dinner menu after that. While the digital content may change based on time of day, updating that content from day to day is difficult and the types and forms of digital content that can be displayed have been limited.

### SUMMARY

Various embodiments herein each include at least one of systems, methods, and software for dynamic network signage distribution and presentment. One embodiment, in the form of a method performed by a digital signage control and scheduling application, includes reading data from a content schedule for digital display system. The content schedule data including data identifying a digital asset retrievable from a Universal Resource Identifier (URI), at least one digital sign on which to present the digital asset, at least one location on each of the at least one digital signs at which the digital asset is to be presented. The method further includes retrieving the digital asset over a network based on the URI and according to the schedule data and invoking a web browser display function to present the retrieved digital asset. In some embodiments, the web browser display function is a portion of or embedded within the digital signage control and scheduling application. This method further includes presenting the retrieved digital asset on each of the at least one digital signs at each identified location thereon.

Another method embodiment includes retrieving a digital asset over a network based on a URI according to schedule data and invoking a web browser display function of a digital signage control system to present the retrieved digital asset on a digital signage system. The method may then present the retrieved digital asset on each of the at least one digital signs of the digital signage system at each identified location thereon.

A further embodiment, in the form of a digital display system, includes at least one digital display device, a network interface device, a processor, and memory. The memory stores a content schedule for the digital display system and instructions executable by the processor to perform data processing activities. The data processing activities may include reading data from the content schedule that identifies a digital asset retrievable via the network interface device from a URI, at least one of the at least one digital display devices on which to present the digital asset, and at least one location on each of the at least one digital display devices at which the digital asset is to be presented. The data processing activities further include retrieving the digital asset via the network interface device based on the URI and according to the schedule data and invoking a web browser display function to present the retrieved digital asset. The data processing activities also include presenting the retrieved digital asset on each of the at least one digital signs at each identified location thereon.

### BRIEF DESCRIPTION OF THE DRAWINGS

FIG. 1 is a logical illustration of a system architecture, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, methods, and software for dynamic network signage distribution and presentment. In some embodiments, website content may be retrieved over a network, such as the Internet, and presented within a digital signage solution. Some such embodiments present webpage content within a web browser presenting container at one or more locations within a digital signage display. In some embodiments, the web browser presenting container is a programmatic element of, embedded within, or otherwise included with a digital signage scheduling and control application that executes to control what, when, and where content is presented by a digital signage system. Including the web browser functionality within the digital signage scheduling and control application provides a known, controlled environment within which to present web site and other web browser presentable digital assets. Inclusion of the web browser functionality also provides greater flexibility for programmatically and configuring how digital assets will be presented.

These and other embodiments are illustrated and described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer-readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or another type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

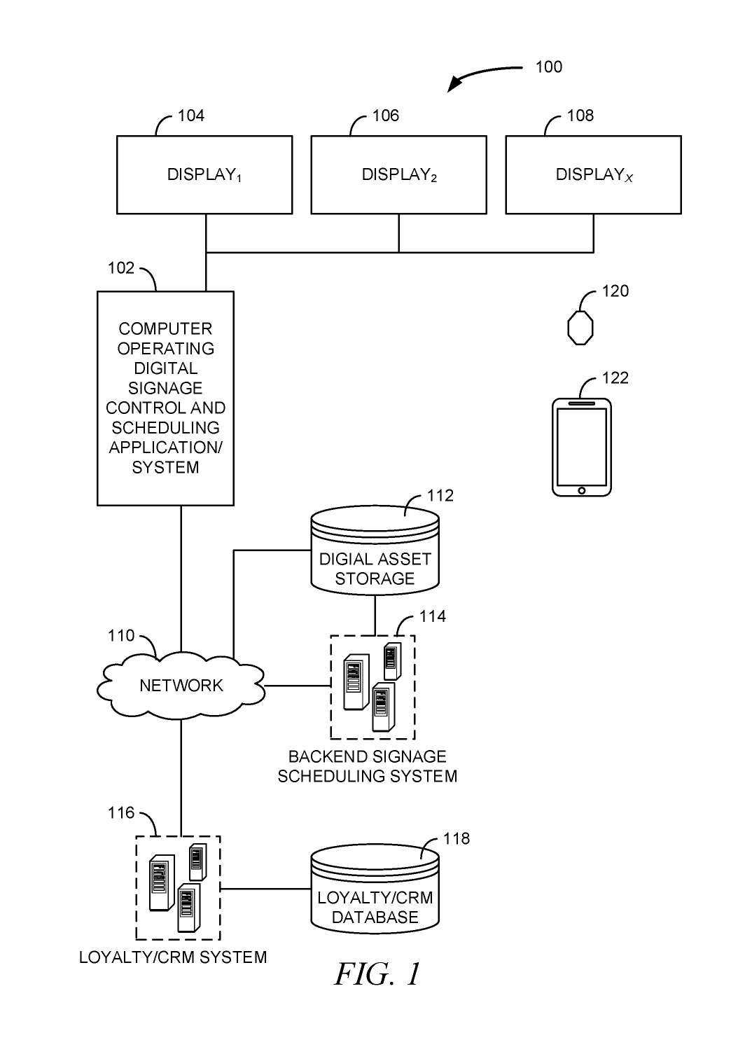

FIG. 1 is a logical illustration of a system 100 architecture, according to an example embodiment. The system 100 includes a digital signage scheduling and control application 102, which may also be referred to as a system, but will be referred to as application 102 at least with regard to the description of FIG. 1. The application 102 executes on a computer to control and present digital assets on one or more displays 104, 106, 108 according to a schedule. The schedule may be maintained by the application 102, modified locally thereto, administered via a network 110, such as by a backend signage scheduling system 114, and otherwise. In some embodiments, the application 102 is not local to the one or more displays 104, 106, 108 and instead communicates with the one or more displays 104, 106, 108 via the network 110. Thus, in some embodiments, the one or more displays 104, 106, 108 may simply be displays that receive a signal from a computer on which the application 102 executes. However, in other embodiments, the one or more displays 104, 106, 108 may receive a signal for what to display over the network 110. Regardless, the one or more displays 104, 106, 108 may be one to any number of displays in various embodiments.

In one embodiment, the application 102 maintains a schedule for presenting digital assets, such as images, video, and other presentable content. The schedule may identify a digital asset to be presented, a time or sequence when the digital asset is to be presented, a duration for presentment, one or more displays on which the digital asset is to be presented, one or more locations within the one or more displays to present the digital asset, effects for transitioning one or both of in and out, and the like. Depending on the digital asset type to be presented, the schedule of some embodiments may also allow for or include data identifying a presentation tool or application for use in presenting the digital asset and any parameters for that tool or application.

For example, a digital asset type may be a webpage in some embodiment and the data may identify a web browser tool embedded within the application 102 for use in presenting the webpage digital asset. In some embodiments, the web browser may be a form or based upon CHROMIUM open source code available from GOOGLE LLC of Menlo Park, Calif. In other embodiments, the web browser may be another open source or proprietary web browser or other digital asset presentment tool.

The parameters for presenting a digital asset within a web browser tool may include webpage scrolling parameters, such as how far, how fast, up, down, left, right, zoom, and the like. Other parameters may include whether to display a border around the webpage or to blend with other portions items presented on a particular display, how to transition in and out of presenting the webpage or between webpages, and the like.

In some embodiments, digital assets to be presented on the one or more displays 104, 106, 108 may be stored locally to the computer on which the application 102 executes or on a network local thereto or the digital assets may be stored or accessed remotely over a broader network 110, such as the Internet. The digital assets may be stored in digital asset storage 112, such as a remotely assessable data storage device, database, or other data storage mechanism. The digital assets may also include webpages accessed over the Internet.

In some embodiments, the webpage may static. In other embodiments, the backend signage scheduling system 114 cycles through a number of webpages based on time of day or scheduled sequence and duration by storing scheduled webpages at a particular URI address (e.g., universal resource locator) known to the application 102. As such, when a scheduled digital asset is a webpage, the application 102 retrieves the webpage and presents it on the one or more displays 104, 106, 108 according to the schedule data.

In some other embodiments, a scheduled webpage digital asset may be dynamically generated based on current data in a store or other location where the application 102 executes or for the benefit of or locale for which the application 102 executes. For example, a customer may be identified as present within a store such as by a mobile device 122 app of the customer receiving a beacon identifier of a BLUETOOTH® beacon 120 present at a particular store. The customer may have an account or other data present in a customer loyalty or customer relationship management (CRM) system 116 and data of the customer may be retrieved from a database. That retrieved data may then be used to generate a custom digital asset, such as a webpage, that includes custom marketing or relationship-related content for presentment on the one more displays 104, 106, 108. In such instances, the schedule of the application 102 include scheduled times for when such custom digital assets are to be requested or the application, loyalty or CRM system 116, or other system or application may have an override ability to provide such custom digital assets upon occurrences of particularly defined events. Other rules may also be used in defining scheduled presentment of digital content, such as may be based on one or more sales factors, outside temperatures (e.g., when the temperature is cold, retrieve digital assets related to warm drinks and hot soup, and when it is warm, retrieve digital assets of cold drinks and ice cream). These retrieved digital assets may be presented as webpages within browser controls in some embodiments.

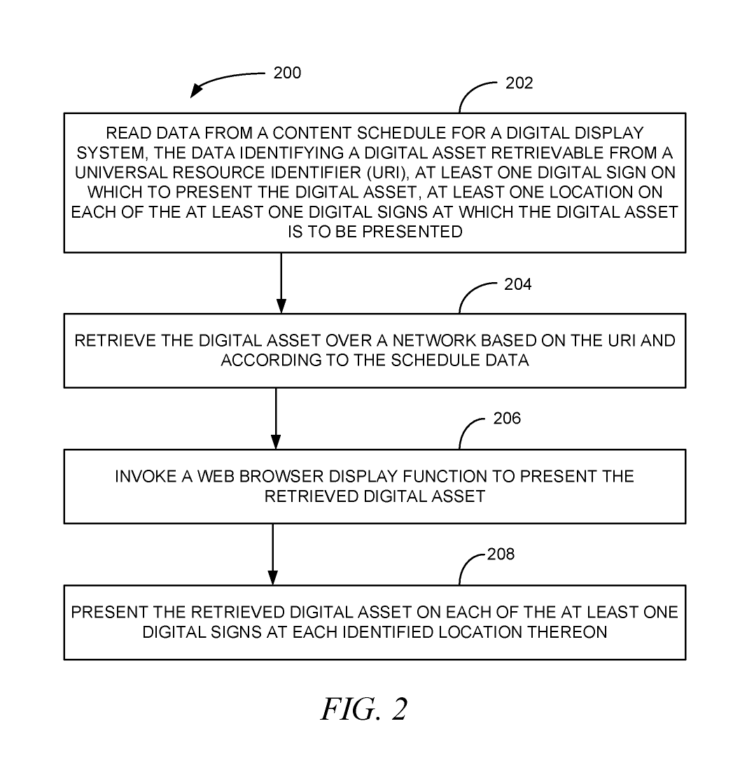

FIG. 2 is a block flow diagram of a method 200, according to an example embodiment. The method 200 is an example of a method that may be performed by the application 102 of FIG. 1, the backend signage scheduling system 114 of FIG. 1, or other similar application or system. The method 200 includes 202 reading data from a content schedule for a digital display system. The data of the schedule may identify a digital asset retrievable from a URI (e.g., a URL), at least one digital sign on which to present the digital asset, and at least one location on each of the at least one digital signs at which the digital asset is to be presented. The method 200 then retrieves 204 the digital asset over a network based on the URI and according to the schedule data. Once retrieved, the method 200 includes invoking 206 a web browser display function to present the retrieved digital asset and presenting 208 the retrieved digital asset on each of the at least one digital signs at each identified location thereon.

In some embodiments of the method 200, the web browser display function is native to, embedded, or otherwise included within an application performing the method 200. The digital asset may be a video data file (e.g., FLASH, AVI, MPEG, etc.). In other embodiments, the digital asset may be a webpage, a graphic or image file (e.g., GIF, JPEG, BMP, etc.), textual document, and the like.

In some embodiments of the method 200, the content schedule for the digital display system includes schedule data identifying when the digital asset is to be presented. The content schedule may also include schedule data identifying a frequency at which the digital asset is to be retrieved, such that the retrieving of the digital asset is performed according to the schedule data. In some of these and some other embodiments of the method 200, the content schedule may include a URI from which to retrieve content schedule updates and data identifying when to attempt retrieval of content schedule updates. In such embodiments, when a content schedule update is retrieved, the method 200 includes implementing the content schedule update.

In some further embodiments of the method 200, the content schedule is dynamic such that a schedule event is callable over a network by another process to cause a digital signage change. For example, in some embodiments, a callable schedule event receives at least one data argument that is used to influence what is presented on at least one digital sign. The call and argument may be generated by a system performing the method 200 and sent to another system over a network to generate or retrieve the dynamic content. In some embodiments, the at least one data argument is a customer identifier, such as may be known from a customer loyalty account identifier (e.g., email address, phone number, account number, known bank card number, data transmitted from a customer mobile device, or other known customer data item). In some such embodiments, the method 200 includes retrieving a particular digital asset based on the customer identifier. In one such embodiment, the particular digital asset is a menu item, such as a hamburger, known in a customer relationship management system as a favorite associated with the customer identifier.

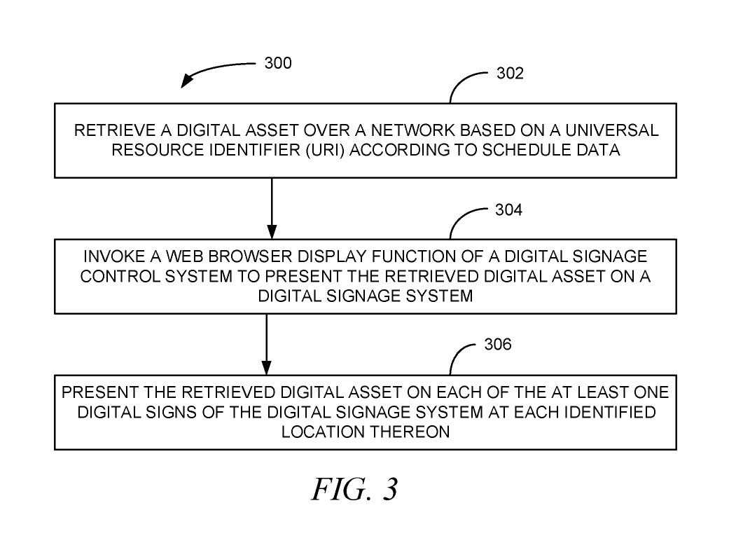

FIG. 3 is a block flow diagram of a method 300, according to an example embodiment. The method 300 includes retrieving 302 a digital asset over a network based on a URI according to schedule data and invoking 304 a web browser display function of a digital signage control system to present the retrieved digital asset on a digital signage system. The method 300 further includes presenting 306 the retrieved digital asset on each of the at least one digital signs of the digital signage system at each identified location thereon.

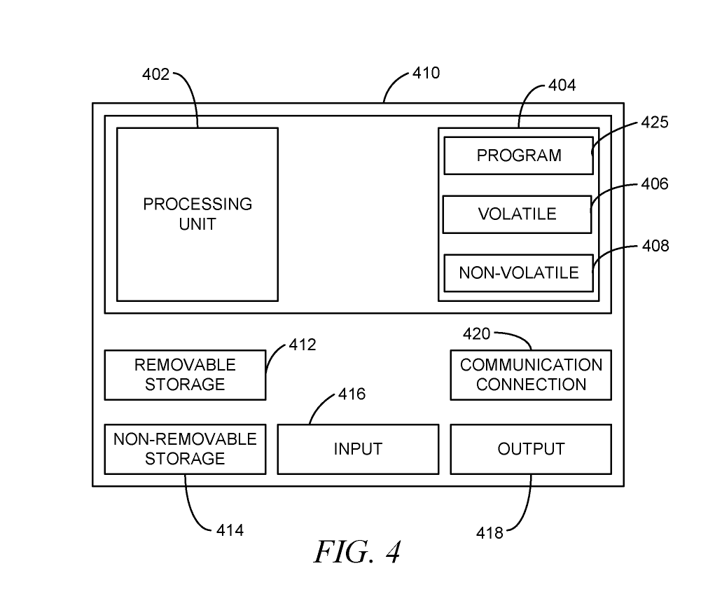

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
reading data from a content schedule for digital display system, the data identifying a digital asset retrievable from a Universal Resource Identifier (URI), at least one digital sign on which to present the digital asset, at least one location on each of the at least one digital signs at which the digital asset is to be presented;
retrieving the digital asset over a network based on the URI and according to the schedule data;
invoking a web browser display function to present the retrieved digital asset; and
presenting the retrieved digital asset on each of the at least one digital signs at each identified location thereon.

2. The method of claim 1, wherein the web browser display function is native to, embedded, or otherwise included within an application performing the method.

3. The method of claim 1, wherein the digital asset is a video data file.

4. The method of claim 1, wherein the content schedule for the digital display system includes schedule data identifying when the digital asset is to be presented.

5. The method of claim 4, wherein the content schedule for the digital display system includes schedule data identifying a frequency at which the digital asset is to be retrieved, such that the retrieving of the digital asset is performed according to the schedule data.

6. The method of claim 1, wherein the content schedule includes a URI from which to retrieve content schedule updates and data identifying when to attempt retrieval of content schedule updates; and
when a content schedule update is retrieved, implementing the content schedule update.

7. The method of claim 1, wherein:
the content schedule is dynamic such that a schedule event is callable over a network by another process to cause a digital signage change.

8. The method of claim 7, wherein a callable schedule event receives at least one data argument that is used to influence what is presented on at least one digital sign.

9. The method of claim 8, wherein the at least one data argument is a customer identifier, the method further comprising:
retrieving a particular digital asset based on the customer identifier.

10. The method of claim 9, wherein the particular digital asset is a menu item known in a customer relationship management system as a favorite associated with the customer identifier.

11. The method of claim 10, wherein the customer identifier is received directly or indirectly from a customer mobile device.

12. A method comprising:
retrieving a digital asset over a network based on a Universal Resource Identifier (URI) according to schedule data;
invoking a web browser display function of a digital signage control system to present the retrieved digital asset on a digital signage system; and
presenting the retrieved digital asset on each of the at least one digital signs of the digital signage system at each identified location thereon.

13. The method of claim 12, wherein the schedule data includes data received over a network as an argument for retrieval of at least one digital asset from the URI over the network.

14. The method of claim 13, wherein the argument is a customer identifier, the method further comprising:
retrieving a particular digital asset based on the customer identifier.

15. The method of claim 14, wherein the particular digital asset is a menu item known in a customer relationship management system as a favorite associated with the customer identifier.

16. A digital display system comprising:
at least one digital display device;
a network interface device;
a processor;
a memory storing a content schedule for the digital display system and instructions executable by the processor to perform data processing activities comprising:
reading data from the content schedule, the data identifying a digital asset retrievable via the network interface device from a Universal Resource Identifier (URI), at least one of the at least one digital display devices on which to present the digital asset, at least one location on each of the at least one digital display devices at which the digital asset is to be presented;
retrieving the digital asset via the network interface device based on the URI and according to the schedule data;
invoking a web browser display function to present the retrieved digital asset; and
presenting the retrieved digital asset on each of the at least one digital signs at each identified location thereon.

17. The digital display system of claim 16, wherein the web browser display function is included within executable instructions stored on the memory device.

18. The digital display system of claim 1, wherein:
the content schedule is dynamic such that a schedule event is callable over a network by another process to cause a digital signage change.

19. The digital display system of claim 18, wherein a callable schedule event receives at least one data argument that is used to influence what is presented on at least one digital display device.

20. The digital display system of claim 19, wherein the at least one data argument is a customer identifier, the data processing activities further comprising:
retrieving a particular digital asset based on the customer identifier.
